(19) United States
(12) Patent Application Publication
(10) Pub. No.: US 2016/0258571 A1
(43) Pub. Date: Sep. 8, 2016

(54) COLLAPSIBLE DINER

(71) Applicant: Prashant Babal, Minnetonka, MN (US)

(72) Inventor: Prashant Babal, Minnetonka, MN (US)

(73) Assignee: Wazir Chand & Co. Pvt. Ltd, Moradabad (IN)

(21) Appl. No.: 14/640,459

(22) Filed: Mar. 6, 2015

(51) Int. Cl. F16M 11/24; A01K 5/01; A01K 29/00; F16M 13/00

(52) U.S. Cl. CPC F16M 11/24; F16M 13/00; A01K 5/0114; A01K 29/00

(57) ABSTRACT

A collapsible diner is described herein. A collapsible diner can include a rigid rectangular horizontal frame, a first rigid leg attached to a first end of the rigid horizontal frame at a first pivot point, wherein the first rigid leg rotates about the first pivot point, and wherein the first rigid leg includes a first cam connected to the first rigid leg, and a second rigid leg attached to a second end of the rigid horizontal frame at a second pivot point, wherein the second rigid leg rotates about the second pivot point, and wherein the second rigid leg includes a second cam connected to the second rigid leg.

### TECHNICAL FIELD

The present disclosure relates to a collapsible diner.

### BACKGROUND

Elevated diners can help to reduce strain on the necks of animals. For instance, larger animals may experience strain on their neck during feeding from a bowl that is placed on the ground (e.g., not elevated). It is therefore desirable to place food and water bowls at an appropriate height (e.g., elevated) relative to the size of the animal.

### BRIEF DESCRIPTION OF THE DRAWINGS

FIG. 1 illustrates a front view of a collapsible diner with rigid legs extended in accordance with one or more embodiments of the present disclosure.

FIG. 2 illustrates a side view of a collapsible diner in accordance with one or more embodiments of the present disclosure.

FIG. 3 illustrates a magnified view of the area designated “A” in FIG. 2 of a collapsible diner in accordance with one or more embodiments of the present disclosure.

FIG. 4 illustrates a magnified view of the area designated “A” in FIG. 2 of a collapsible diner in accordance with one or more embodiments of the present disclosure.

FIG. 5 illustrates a magnified view of the area designated “A” in FIG. 2 of a collapsible diner in accordance with one or more embodiments of the present disclosure.

FIG. 6 illustrates a top view of a rigid rectangular horizontal frame in accordance with one or more embodiments of the present disclosure.

FIG. 7 illustrates a front view of a collapsible diner with rigid legs collapsed in accordance with one or more embodiments of the present disclosure.

### DETAILED DESCRIPTION

Embodiments of collapsible diners are described herein. For example, one or more embodiments include a rigid rectangular horizontal frame, a first rigid leg attached to a first end of the rigid horizontal frame at a first pivot point, wherein the first rigid leg rotates about the first pivot point, and wherein the first rigid leg includes a first cam connected to the first rigid leg, and a second rigid leg attached to a second end of the rigid horizontal frame at a second pivot point, wherein the second rigid leg rotates about the second pivot point, and wherein the second rigid leg includes a second cam connected to the second rigid leg.

A diner can be used to help reduce the strain on a larger animal's neck when the animal is eating and/or drinking from a bowl housed by the diner by elevating the bowl off the ground. By elevating the bowl, the larger animal may not need to bend down as far to reach the bowl as compared to a bowl placed on the ground.

Previous approaches to diners have used a frame with non-collapsible legs to elevate a bowl for a larger animal. However, these approaches can suffer from various issues such as the diner being difficult to ship to a retailer and/or a customer, difficult to display (e.g., requires substantial shelf space), as well as having higher packaging costs. Further, a diner with non-collapsible legs can be difficult to store for a retailer and/or customer.

Using collapsible legs, in accordance with the present disclosure, can allow for lower shipping costs for manufacturers, as well as allow for easier storage and display at a retailer. For example, a retailer may display the collapsible diner in a box or collapsed out of the box. Further, a customer can more easily store a diner with collapsible legs when it is not needed for use.

In the following detailed description, reference is made to the accompanying drawings that form a part hereof. The drawings show by way of illustration how one or more embodiments of the disclosure may be practiced.

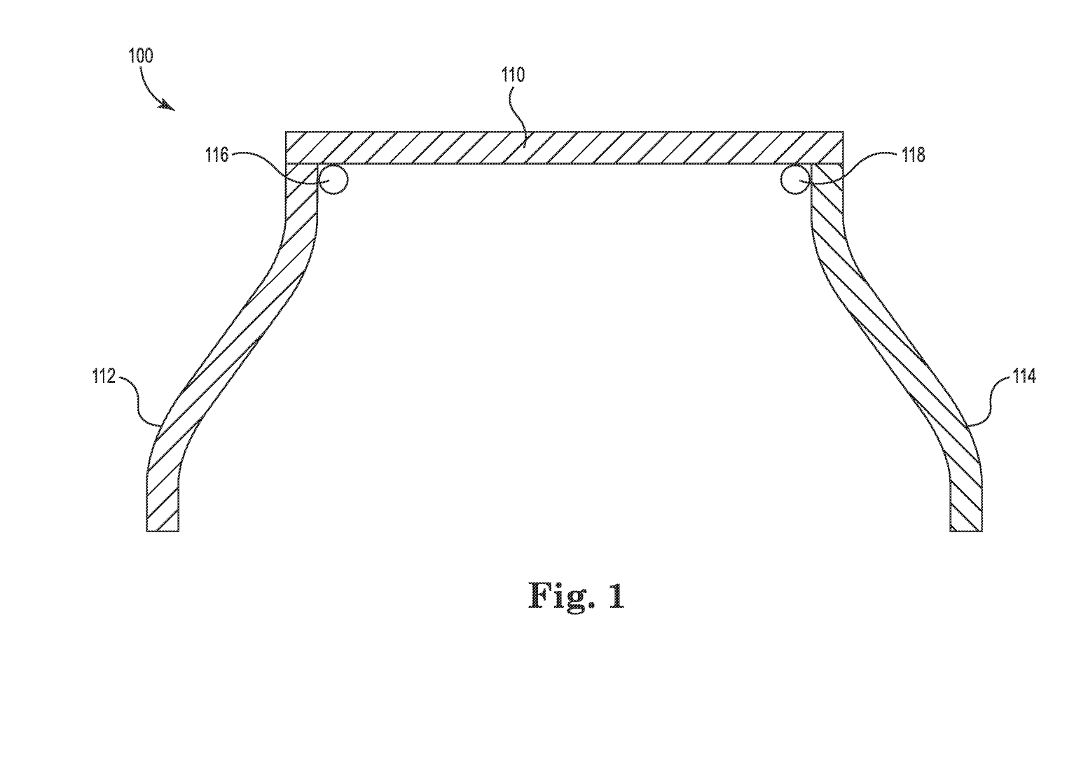

Directional terms such as “upper”, “lower”, “downward”, “upward”, “horizontal”, “vertical”, “left”, “right”, are used with reference to the component orientation depicted in FIG. 1. These terms are used for example purposes only and are not intended to limit the scope of the appended claims.

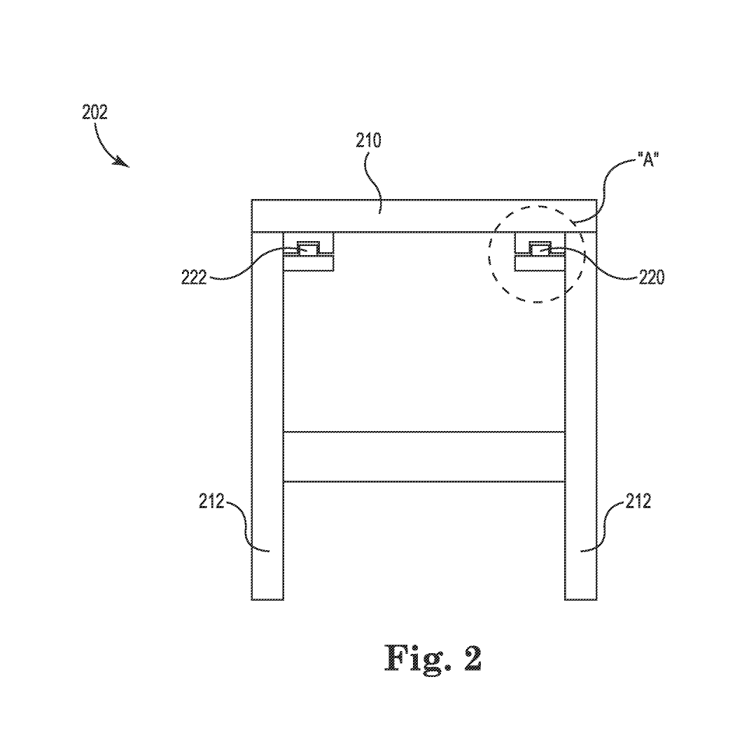

The figures herein follow a numbering convention in which the first digit or digits correspond to the drawing figure number and the remaining digits identify an element or component in the drawing. Similar elements or components between different figures may be identified by the use of similar digits. For example, 110 may reference element “10” in FIG. 1, and a similar element may be reference as 210 in FIG. 2.

As used herein, “a” or “a number of” something can refer to one or more such things. For example, “a number of cross-members” can refer to one or more cross-members.

FIG. 1 illustrates a front view 100 of a collapsible diner with rigid legs extended in accordance with one or more embodiments of the present disclosure. As shown in FIG. 1, the collapsible diner can include a rigid rectangular horizontal frame 110, a first rigid leg 112, a second rigid leg 114, a first pivot point 116, and a second pivot point 118.

The rigid horizontal frame 110 can be a frame with a number of cross-members located such that a bowl can be placed within the frame to elevate the bowl, as will be further described herein. The frame 110 can be made of metal. However, embodiments of the present disclosure are not so limited. For example, the frame 110 can be made of any other suitable material.

The first rigid leg 112 can be a one of a number of legs to elevate the frame 110. The first rigid leg 112 can be made of metal (e.g., wrought iron). However, embodiments of the present disclosure are not so limited. For example, the first rigid leg 112 can be made of any other suitable material. The first rigid leg 112 can further include a first cam connected to the first rigid leg 112, as will be further described herein.

The collapsible diner can include a first pivot point 116. The first pivot point 116 can be a hinge that connects the first rigid leg 112 to the rigid rectangular horizontal frame 110. Further, the first pivot point 116 can allow the first rigid leg 112 to rotate (e.g., collapse).

The first pivot point 116 can allow the first rigid leg 112 to rotate in only one plane. For example, the first rigid leg 112 can rotate away (e.g., from a collapsed state to a non-collapsed state) from frame 110 about the first pivot point 116, as illustrated in FIG. 1.

The second rigid leg 114 can be a one of a number of legs to elevate the frame 110. The second rigid leg 114 can be made of metal (e.g., wrought iron). However, embodiments of the present disclosure are not so limited. For example, the second rigid leg 114 can be made of any other suitable material. The second rigid leg 114 can include a second cam connected to the second rigid leg 114, as will be further described herein.

The collapsible diner can include a second pivot point 118. The second pivot point 118 can be a hinge that connects the second rigid leg 114 to the rigid rectangular horizontal frame 110. Further, the second pivot point 118 can allow the second rigid leg 114 to rotate (e.g., collapse).

The second pivot point 118 can allow the second rigid leg 114 to rotate in only one plane. For example, the second rigid leg 114 can rotate away (e.g., from a collapsed state to a non-collapsed state) from frame 110 about the second pivot point 118, as illustrated in FIG. 1.

The first rigid leg 112 and the second rigid leg 114 can be shaped such that the distance between the bottom of the first rigid leg 112 and the bottom of the second rigid leg 114 is greater than the distance between the top of the first rigid leg 112 and the top of the second rigid leg 114. For example, the distance between the bottom of the first rigid leg 112 and the second rigid leg 114 is greater (e.g., 24 inches) than the distance between the top of the first rigid leg 112 and the second rigid leg 114 (e.g., 18 inches).

The length of the rigid horizontal frame 110 can be the same as the distance between the top of the first rigid leg 112 and the second rigid leg 114. For example, the length of the rigid horizontal frame 110 and the distance between the top of the first rigid leg 112 and the second rigid leg 114 can be the same (e.g., both 18 inches).

The first end of the rigid horizontal frame 110 (e.g., left side as illustrated in FIG. 1) can include a first slot, wherein the first slot can receive the first cam in an interference fit, as will be further described herein.

The second end of the rigid horizontal frame 110 (e.g., right side, as illustrated in FIG. 1) can include a second slot, wherein the second slot can receive the second cam in an interference fit. An interference fit, as used herein, is a fastening between a cam and ball bearings that prevents the first and the second rigid legs from collapsing (e.g., ball lock system) about their respective pivot points, as will be further described herein.

FIG. 2 illustrates a side view 202 of a collapsible diner with rigid legs extended in accordance with one or more embodiments of the present disclosure. As shown in FIG. 2, the collapsible diner can include a rigid rectangular horizontal frame 210, a first rigid leg 212, a first cam 220, and a second cam 222.

The height of the rigid horizontal frame 210 can be relative to the width of the first rigid leg 212. For example, the height of the frame 210 can be proportional to the width of the first and the second rigid legs in order to maintain stability for the diner.

In some embodiments, the height of the rigid horizontal frame 210 can be selected based on the size of the animal the diner is intended for. For example, the height of the rigid horizontal frame 210 of a diner selected for a small dog can be 6 inches. As another example, the height of the rigid horizontal frame 210 of a diner selected for a larger dog can be 12 inches.

The first end (e.g., as shown in FIG. 2) of the rigid horizontal frame 210 can include a first slot that receives the first cam 220 in an interference fit. For example, when the first rigid leg 212 is rotated (e.g., from a collapsed state to a non-collapsed state), the first cam 220 is engaged in an interference fit, as will be further described herein.

The second end (e.g., the right side as previously discussed in connection with FIG. 1) of the rigid horizontal frame 210 can include a second slot that receives the second cam 222 in an interference fit. For example, when the second rigid leg is rotated (e.g., from a collapsed state to a non-collapsed state), the second cam 222 is engaged in an interference fit, as will be further described herein. As shown in FIG. 2, the second cam 222 can be located diagonally across the rigid horizontal frame 210 from the first cam 220.

Each of the first rigid leg 212 and second rigid leg can pivot away (e.g., from a collapsed state to a non-collapsed state) from the rigid horizontal frame 210 to engage the first cam 220 and the second cam 222 in the interference fits in the first slot and the second slot (e.g., ball lock system).

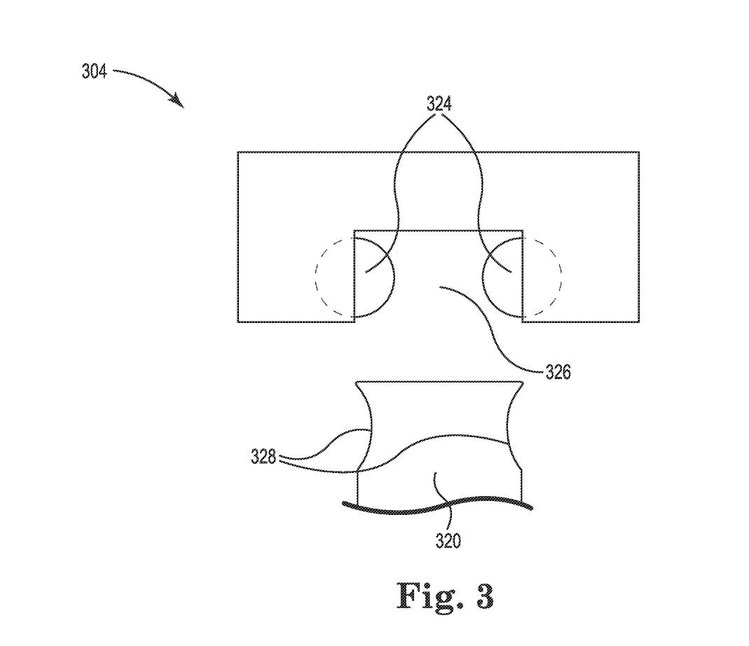

FIG. 3 illustrates a magnified view 304 of the area designated “A” in FIG. 2 of a collapsible diner in accordance with one or more embodiments of the present disclosure. As shown in FIG. 3, the collapsible diner can include a first cam 320, two ball bearings 324, a first slot 326, and grooves 328.

The first cam 320 can include grooves 328. The grooves 328 can be located on opposite sides of the first cam 320. For example, the first cam 320 can include two grooves 328, where the two grooves 328 can be in positions facing away from each other. The grooves 328, as used herein, can be semi-circular cuts in the surfaces of the first cam 320.

Although not shown in FIG. 3, the second cam (e.g., second cam 222 as illustrated in FIG. 2) can include two grooves similar to grooves 328 as described in connection with the first cam 320. The grooves can be located on opposite sides of the second cam 222. For example, the second cam 222 can include two grooves, wherein the two grooves can be in positions facing away from each other.

The first slot 326 can include two ball bearings 324. Each of the two ball bearings 324 can be located on opposing sides of the first slot 326. For example, the two ball bearings can be in positions that face towards each other.

Although not shown in FIG. 3, a second slot can include two additional ball bearings. Each of the two additional ball bearings in the second slot can be located on opposing sides of the second slot. For example, the two additional ball bearings in the second slot can be in positions that face towards each other.

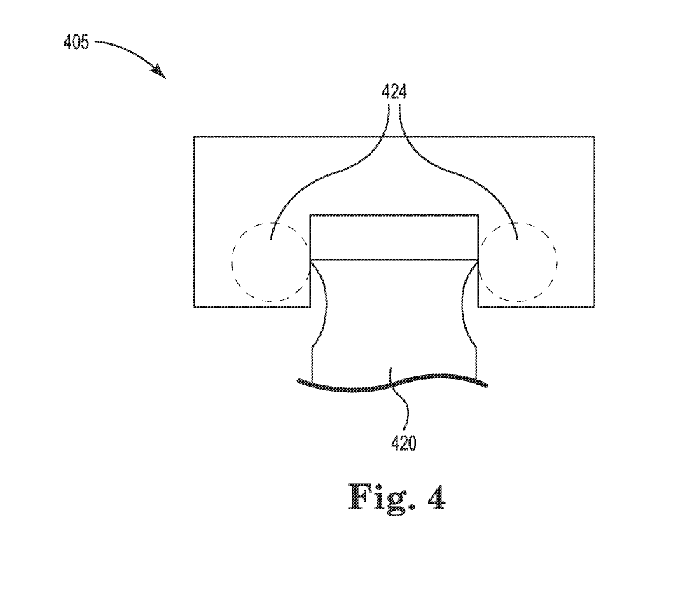

FIG. 4 illustrates a magnified view 405 of the area designated “A” in FIG. 2 of a collapsible diner in accordance with one or more embodiments of the present disclosure. As shown in FIG. 4, the collapsible diner can include a first cam 420 and two ball bearings 424.

The two ball bearings 424 can move laterally away from the first cam 420 when engaging or disengaging the first cam 420 in the interference fit in the first slot (e.g., slot 326 as illustrated in FIG. 3). For example, when engaging the interference fit, the first cam 420 can push the two ball bearings 424 laterally while the first cam 420 moves into the first slot 326.

Although not shown in FIG. 4, two additional ball bearings can move laterally away from a second cam when engaging or disengaging the second cam in an interference fit in a second slot. For example, when engaging an interference fit, the second cam can push the two additional ball bearings laterally while the second cam moves into the second slot.

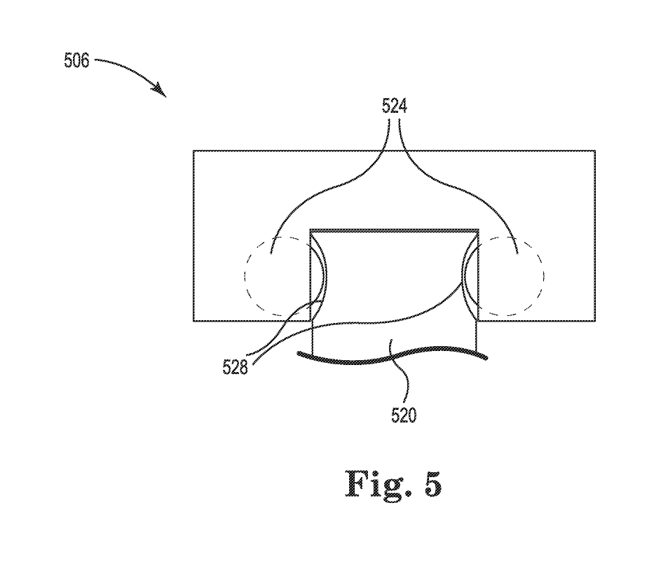

FIG. 5 illustrates a magnified view 506 of the area designated “A” in FIG. 2 of a collapsible diner in accordance with one or more embodiments of the present disclosure. As shown in FIG. 5, the collapsible diner can include a first cam 520, two ball bearings 524, and grooves 528.

The two ball bearings 524 can keep the first cam 520 engaged in an interference fit within the first slot 326 (e.g., ball lock system), as described in connection with FIG. 3. For example, the two ball bearings 524 prevent the first cam 520 from slipping out of the interference fit within the first slot (e.g., slot 326 as illustrated in FIG. 3).

Although not shown in FIG. 5, two additional ball bearings can keep a second cam engaged in an interference fit within a second slot (e.g., ball lock system). For example, the two additional ball bearings prevent the second cam from slipping out of the interference fit within the second slot.

The positions of the two ball bearings 524 within the first slot 326 can be adjusted via a number of set screws. Further, the positions of the two ball bearings within a second slot can be adjusted via a number of set screws.

The positions of the two ball bearings 524 within the first slot 326 can be adjustable such that the two ball bearings 524 are positioned to sit within the two grooves 528 on the first cam 520 when the first cam 520 is engaged in the interference fit within the first slot 326. For example, the two ball bearings 524 can be adjusted laterally to ensure fit within the two grooves 528 of first cam 520.

Although not shown in FIG. 5, the positions of two additional ball bearings within a second slot can be adjustable such that the two additional ball bearings are positioned to sit within two grooves on a second cam when the second cam is engaged in an interference fit within a second slot. For example, the two additional ball bearings can be adjusted laterally to ensure fit within the two grooves of the second cam.

The interference fit of the first cam 520 in the first slot (e.g., slot 326 as illustrated in FIG. 3) and the second cam in the second slot can keep the first rigid leg (e.g., leg 112 as illustrated in FIG. 1) and the second rigid leg (e.g., leg 114 as illustrated in FIG. 1) in a non-collapsible position.

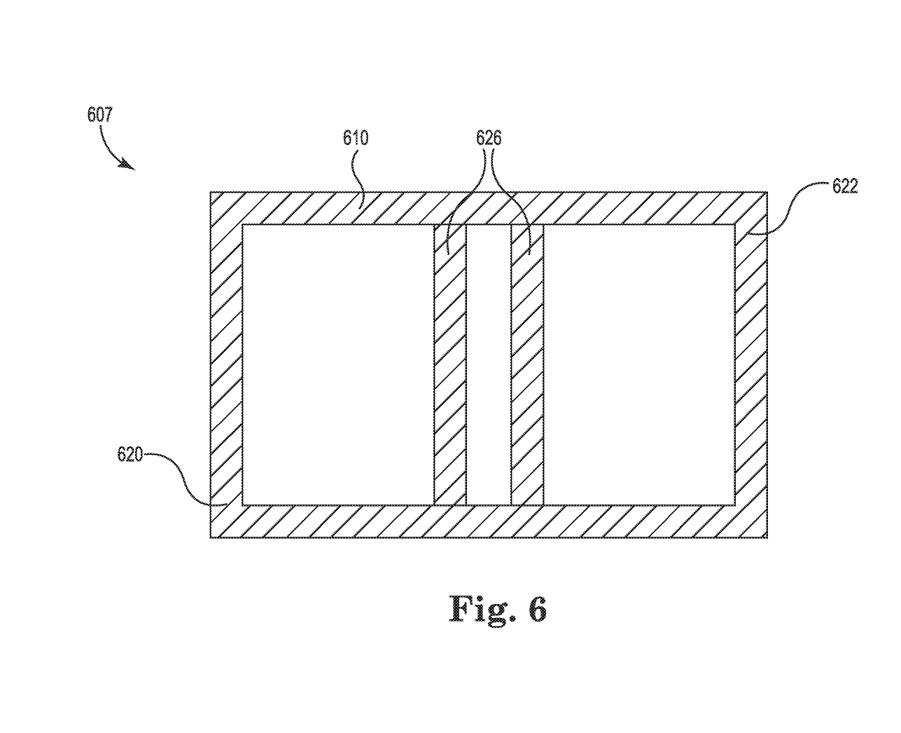

FIG. 6 illustrates a top view 607 of a rigid rectangular horizontal frame in accordance with one or more embodiments of the present disclosure. As shown in FIG. 6, the collapsible diner can include a rigid rectangular horizontal frame 610 and a number of cross-members 626.

The number of cross-members 626 can be placed to fit a number of bowls within the rigid rectangular horizontal frame 610. For example, the number of cross-members 626 can be placed to allow a number of bowls (e.g., two bowls) to be placed within the frame 610.

The number of cross-members 626 can be placed to allow a number of bowls to fit within the rigid horizontal frame 610. For example, the number of cross-members 626 can be placed to fit two bowls with the same diameter (e.g., 5 inches). In another example, the number of cross-members 626 can be placed closer together to fit two bowls with a slightly larger diameter (e.g., 6 inches). Further, the number of cross-members 626 can be placed to fit more than two bowls (e.g., three bowls) with a smaller diameter (e.g., 3 inches).

In some embodiments, the number of cross-members 626 can be placed to allow a number of different-sized bowls to fit within the rigid horizontal frame 610. For example, the number of cross-members 626 can be placed to allow two bowls with different-sized diameters to fit within the rigid horizontal frame 610 (e.g., one bowl having a diameter of 6 inches, and a second bowl having a diameter of 5 inches). Examples of the present disclosure may allow for rigid horizontal frame to house more or less than two bowls.

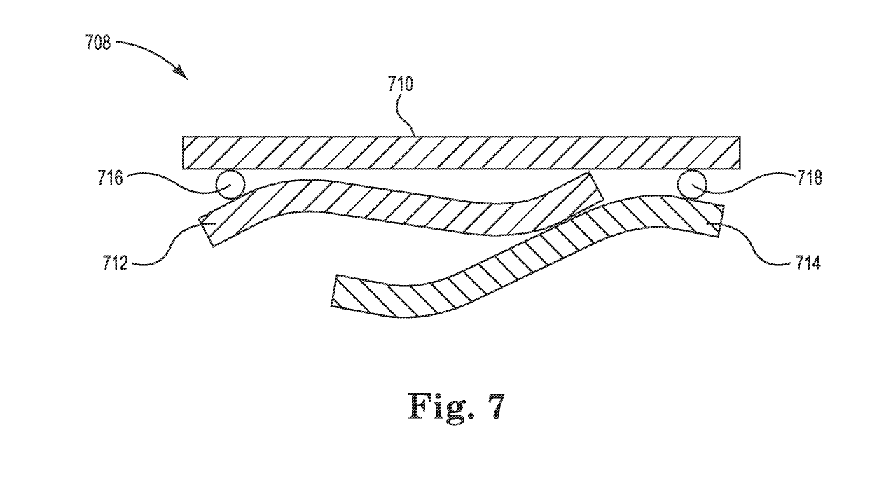

FIG. 7 illustrates a front view 708 of a collapsible diner with rigid legs 712 and 714 collapsed in accordance with one or more embodiments of the present disclosure. As shown in FIG. 7, the collapsible diner can include a rigid rectangular horizontal frame 710, a first rigid leg 712, a second rigid leg 714, a first pivot point 716, and a second pivot point 718.

The first rigid leg 712 and the second rigid leg 714 can be collapsible about the first pivot point 716 and the second pivot point 718. For example, the first rigid leg 712 can pivot about the first pivot point 716 towards (e.g., from a non-collapsed state to a collapsed state) the rigid horizontal frame 710. As an additional example, the second rigid leg 714 can pivot about the second pivot point 718 towards (e.g., from a non-collapsed state to a collapsed state) the rigid horizontal frame 710.

Although described as pivoting towards (e.g., from a non-collapsed state to a collapsed state) the rigid horizontal frame, embodiments of the present disclosure are not so limited. For example, the first rigid leg 712 and the second rigid leg 714 can pivot away (e.g., from a collapsed state to a non-collapsed state) from the rigid horizontal frame 710.

The collapsible diner can require no tools to collapse the first rigid leg 712 and/or the second rigid leg 714. For example, a user who is preparing to store the collapsible diner can simply apply pressure to the first rigid leg 712 and second rigid leg 714 to disengage the interference fit of the first and second cams and pivot the first rigid leg 712 and second rigid leg 714 about the first pivot point 716 and second pivot point 718, respectively, to collapse the rigid legs.

The collapsible diner can require no tools for assembly. For example, the collapsible diner can be sent to a retailer and/or a customer pre-assembled (e.g., requiring no assembly).

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

These embodiments are described in sufficient detail to enable those of ordinary skill in the art to practice one or more embodiments of this disclosure. It is to be understood that other embodiments may be utilized and that process and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1. A collapsible diner, comprising:
a rigid rectangular horizontal frame;
a first rigid leg attached to a first end of the rigid horizontal frame at a first pivot point, wherein the first rigid leg rotates about the first pivot point, and wherein the first rigid leg includes a first cam connected to the first rigid leg;
a second rigid leg attached to a second end of the rigid horizontal frame at a second pivot point, wherein the second rigid leg rotates about the second pivot point, and wherein the second rigid leg includes a second cam connected to the second rigid leg, the second cam located diagonally across the rigid rectangular horizontal frame from the first cam;
the first end of the rigid horizontal frame including a first slot, wherein the first slot receives the first cam in an interference fit; and
the second end of the rigid horizontal frame including a second slot, wherein the second slot receives the second cam in an interference fit.

2. The collapsible diner of claim 1, wherein the interference fit of the first cam in the first slot and the second cam in the second slot keeps the first rigid leg and the second rigid leg in a non-collapsible position.

3. The collapsible diner of claim 1, wherein each of the first rigid leg and the second rigid leg pivot away from the rigid horizontal frame to engage the first cam and the second cam in the interference fits in the respective first and second slots.

4. The collapsible diner of claim 1, wherein each of the first cam and the second cam include grooves located on opposite sides of each of the first cam and the second cam.

5. The collapsible diner of claim 1, wherein each of the first and the second slots include ball bearings, wherein each of the ball bearings is located on opposing sides of each of the first and the second slots.

6. The collapsible diner of claim 5, wherein the ball bearings located at each of the first and the second slots move laterally away from each of the first and the second cams when engaging or disengaging the interference fit.

7. The collapsible diner of claim 5, wherein the ball bearings of each of the first and the second slots keep the first and the second cams engaged in the interference fit within the respective first and second slots.

8. The collapsible diner of claim 5, wherein the positions of the ball bearings in the first and the second slots are adjustable via a number of set screws.

9. The collapsible diner of claim 8, wherein the positions of the ball bearings are adjustable such that the ball bearings are positioned to sit within grooves on the first and the second cams when the first and the second cams are engaged in the interference fit.

10. A collapsible diner, comprising:
a rigid rectangular horizontal frame including a number of cross-members such that a number of bowls fit within the rigid horizontal frame, and wherein a height of the rigid horizontal frame is relative to a width of the collapsible diner;
a first rigid leg attached to a first end of the rigid horizontal frame at a first pivot point wherein the first rigid leg rotates about the first pivot point, and wherein the first rigid leg includes a first cam connected to the first rigid leg;
a second rigid leg attached to a second end of the rigid horizontal frame at a second pivot point wherein the second rigid leg rotates about the second pivot point, and wherein the second rigid leg includes a second cam connected to the second rigid leg, the second cam located diagonally across the rigid rectangular horizontal frame from the first cam;
the first end of the rigid horizontal frame including a first slot, wherein the first slot receives the first cam in an interference fit;
the second end of the rigid horizontal frame including a second slot, wherein the second slot receives the second cam in an interference fit;
wherein the first and the second rigid legs are shaped such that a distance between a bottom of the first rigid leg and a bottom of the second rigid leg is greater than a distance between a top of the first rigid leg and a top of the second rigid leg; and
wherein a length of the rigid horizontal frame is the same as the distance between the top of the first rigid leg and the top of the second rigid leg.

11. The collapsible diner of claim 10, wherein the first and the second rigid legs are collapsible about the first and the second respective pivot points.

12. The collapsible diner of claim 10, wherein the number of cross-members are placed to allow a number of different-sized bowls to fit within the rigid horizontal frame.

13. The collapsible diner of claim 10, wherein the height of the rigid horizontal frame is relative to the width of the collapsible diner for stability.

14. The collapsible diner of claim 10, wherein the diner requires no tools to collapse the first and second rigid legs.

15. The collapsible diner of claim 10, wherein the diner requires no tools for assembly.

16. A collapsible diner, comprising:
a rigid rectangular horizontal frame;
a first rigid leg attached to a first end of the rigid horizontal frame at a first pivot point, wherein the first rigid leg rotates about the first pivot point, and wherein the first rigid leg includes a first cam connected to the first rigid leg;
a second rigid leg attached to a second end of the rigid horizontal frame at a second pivot point, wherein the second rigid leg rotates about the second pivot point, and wherein the second rigid leg includes a second cam connected to the second rigid leg, the second cam located diagonally across the rigid rectangular horizontal frame from the first cam;
wherein the first rigid leg and the second rigid leg are collapsible about the respective first pivot point and second pivot point, and wherein the first rigid leg and the second rigid leg require no tools to collapse;
the first end of the rigid horizontal frame including a first slot, wherein the first slot receives the first cam in an interference fit;
the second end of the rigid horizontal frame including a second slot, wherein the second slot receives the second cam in an interference fit; and
wherein the interference fit of the first and the second cam keep the first and the second cam in the respective first slot and the second slot.

17. The collapsible diner of claim 16, wherein each of the first rigid leg and the second rigid leg pivot toward the rigid horizontal frame to collapse the first rigid leg and the second rigid leg.

18. The collapsible diner of claim 16, wherein each of the first cam and the second cam include grooves located on opposite sides of each of the first cam and the second cam.

19. The collapsible diner of claim 16, wherein each of the first and the second slots include ball bearings, wherein each of the ball bearings is located on opposing sides of each of the first and the second slots.

20. The collapsible diner of claim 19, wherein the ball bearings located at each of the first and the second slots move laterally away from each of the first and the second cams when engaging or disengaging the interference fit.
